(19) United States
(12) Patent Application Publication
(10) Pub. No.: US 2005/0123158 A1
(43) Pub. Date: Jun. 9, 2005

(54) Dispensing of hearing aids

(76) Inventor: Kellie Walker, East Wynard, Tasmania (AU)

Correspondence Address: Edwin D Schindler, Five Hirsch Avenue, P O Box 966, Coram, NY, 11727-0966, US

(21) Appl. No.: 10/501,656

(22) PCT Filed: Jan. 15, 2003
(86) PCT No.: PCT/AU03/00030

(30) Foreign Application Priority Data
Jan. 15, 2002 (AU) PR 9967

(51) Int. Cl. H04R 25/00

(52) U.S. Cl. 381/312; 381/322; 381/328

(57) ABSTRACT

An apparatus and related method for aiding the dispensation of a hearing aid, which is able to test the perception of a patient's hearing and determine the correct amplification of the hearing aid, includes a plug adapted to be received within a patient's ear. The plug has two tubes passing therethrough, with a first tube carrying the sound emitted from a source of sound and a second tube for acting as a vent within the patient's hear.

This invention relates to the dispensing of hearing aids and, in particular, to a device which aids in such dispensing being particularly applicable to programmable hearing aids.

Many modern hearing aids are programmable. Programmability of hearing aids enables them to be able to be adapted to each individual's hearing impairment and, as such, can provide an aid which is more acceptable than was previously the case.

Testing of an individual's hearing ability is usually performed with an audiometer which is able to test a range of frequencies from 125 Hz to 8000 Hz with a decibel range from −20 dB to 120 dB. This can be done through the use of headphones or ear insertions and provides the dispenser with an audiogram depicting a client's hearing capacity, thus enabling and indication of his/her impairment to be derived.

The audiometry results enable programming of a “demonstration” behind the ear hearing aid. The sound output of this hearing aid can be amplified into the client's ear to provide the client with an indication of the desired amplification properties required to compensate for their hearing impairment.

The difficulty which occurs with these “demonstration” aids is that whilst amplification of sound output may be relatively accurate, the impression received by the client is often not.

It is common practice for most custom made hearing aids or custom made ear moulds to incorporate a vent and, depending upon the types of hearing impairment and the correction necessary, these vents can have variable diameters and can also extend to varying distances within the ear canal. The vent provides the user with an accurate impression of their own voice and are thus critical for acceptance and use of the hearing aid by the client.

Once the hearing aid has been cast for a particular individual comprising a prescribed form of vent it is not always possible to change this, therefore accurate determination of the vent requirements are imperative.

Previous methods and devices of dispensing hearing aids have not provided a means whereby the optimum venting requirements can be fully ascertained during testing and trialing procedures. It is an object of the present invention to overcome or substantially ameliorate the disadvantages of the prior art.

The invention provides, for use in testing the perception of hearing and the required amplification of a hearing aid, a plug adapted to be received in a client's ear which has passing therethrough two tubes, one which carries the output sound from a source, normally a hearing aid programmed to compensate for the client's disability, into the ear and the other which acts as a vent.

The device is designed to enable the hearing impaired person to get a truer and more accurate indication of their own voice and of the sound output of a hearing aid.

According to the invention, there is provided a tube which acts as a vent that can have different diameters and different lengths to enable the optimum size and position of the vent in a programmed hearing aid to be ascertained.

In order that the invention may be more readily understood I shall describe a particular form of the invention by way of exemplification. Reference will be made to the accompanying drawings in which:

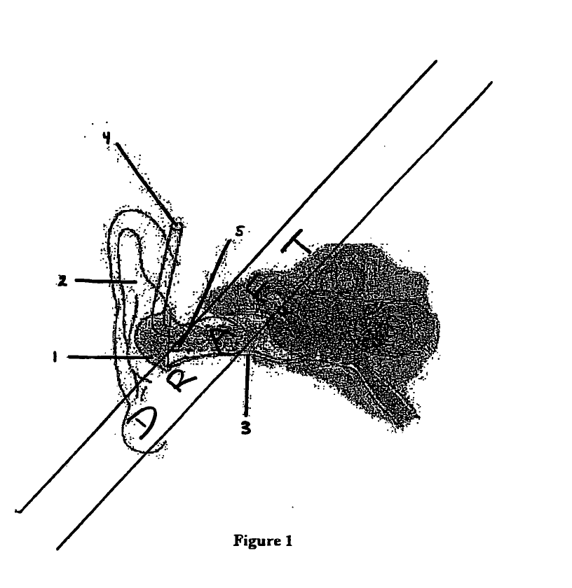

FIG. 1 shows an embodiment of the invention in which the disposable variable vented ear mould is inserted into the ear canal; and

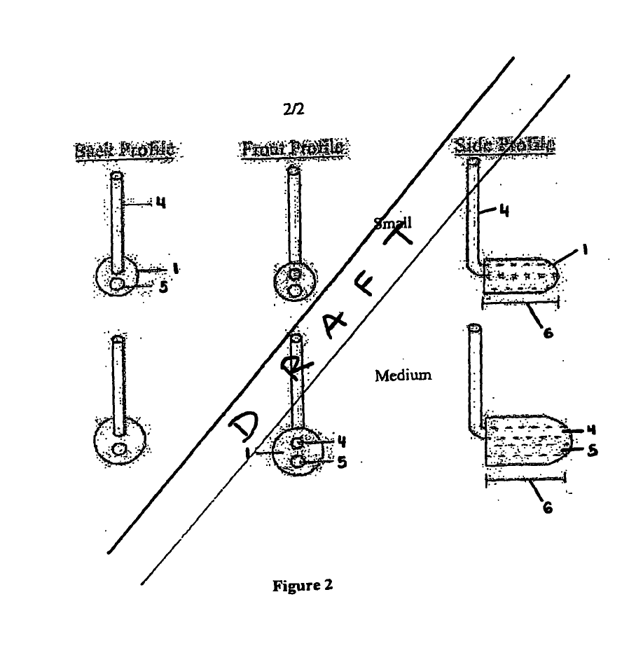

FIG. 2 shows a front, back and side view of the device.

FIGS. 1 and 2 show an ear plug 1 made from a resilient material which is adapted to be located in a client's ear 2 and to effectively reduce occlusion in the ear canal 3.

The material from which this plug 1 is made can vary widely but will normally be a foam material which can be compressed whilst the plug is inserted but, once inserted, moulds the client's ear canal 3 so as to make good contact with the skin.

Passing through the plug there is a first tube 4 which can preferably be a standard through tubing, which acts as a sound tube to carry the output sound from a source, normally a hearing aid which, for convenience, could be a behind the ear aid but could equally well be a bench mounted device usable for test purposes.

Also passing through the plug there is a vent aperture 5 which can preferably be a synthetic plastics tube which has a wall thickness sufficient not to be unduly distorted when the plug is placed in the ear.

The practitioner would have a set of these plugs, which are preferably disposable, having vents of differing lengths 6 and diameters.

There may even be formed with, say, a flared inner end so that they can closely match vents which are used with hearing aids.

In order to test the effectiveness of the proposed hearing aid the aid is first programmed to satisfy what is believed to be the required correction for the particular client. Depending upon the extent and type of hearing impairment, the plug which has a vent member 5 passing through which, in the opinion of the dispenser, is likely to give an optimum result is selected.

The sound tube 4 is then connected to the hearing aid and the hearing aid is then trialed by the client either to consider a range of prerecorded sounds or otherwise, and the client speaks with the aid in position, and, from this, the practitioner can identify whether the aid is effective as far as correction of the hearing loss is concerned and, further, whether it gives the client comfort both as far as the sound is concerned and, particularly, the sound of his/her own voice.

If it is believed that the trial is not optimum it is possible to replace the plug 1 with a plug with a different vent 5 to see whether this gives a more satisfactory result. Increasing the vent to reduce occlusion or decreasing to avoid feedback.

Once the best arrangement has been achieved then the client can have a good indication as to how effective a hearing aid manufactured for the client and having the particular properties would be and, provided he/she is satisfied, then the dispenser can take normal impressions of the client's ears and order a hearing aid or custom made ear mould having the desired physical properties.

1-9. (canceled)

10. An apparatus for testing a patient's perception of hearing and for determining a correct amplification of a hearing aid prior to dispensation of the hearing aid to the patient, comprising:
a source for outputting a sound; and,
a plug fitable within an ear of a patient being tested for a hearing aid, said plug having a first tube for carrying said sound from said source into the ear of the patient and a second tube for venting the ear.

11. The apparatus for testing a patient's perception of hearing and for determining a correct amplification of a hearing aid according to claim 10, said plug being made of a resilient material for reducing occlusion, or feedback, in an ear canal of the patient.

12. The apparatus for testing a patient's perception of hearing and for determining a correct amplification of a hearing aid according to claim 11, wherein said resilient material is a foam material capable of being inserted into the ear canal of the patient and expandable for contacting a periphery of the ear canal for creating a flexible feedback reducing seal.

13. The apparatus for testing a patient's perception of hearing and for determining a correct amplification of a hearing aid according to claim 10, wherein said source for outputting a sound includes means for emitting a plurality of prerecorded sounds.

14. The apparatus for testing a patient's perception of hearing and for determining a correct amplification of a hearing aid according to claim 10, wherein said second tube of said plug is made of a plastic having a wall thickness sufficient for eliminating sound distortion when said plug is placed in the ear of the patient.

15. The apparatus for testing a patient's perception of hearing and for determining a correct amplification of a hearing aid according to claim 10, wherein said second tube of said plug includes means for varying diameter and length for said second tube for optimizing its size and positioning within the ear of the patient.

16. A method for testing a patient's perception of hearing and for determining a correct amplification of a hearing aid prior to dispensation of the hearing aid to the patient, comprising the steps of:
inserting a plug fitable within an ear of a patient being tested for a hearing aid, said plug having a first tube for carrying sound from a source into the ear of the patient and a second tube for venting the ear;
attaching said first tube of said plug to a source for outputting a sound;
activating the source for outputting a sound so that the sound passes through said first tube of said plug and into the patient's ear;
measuring the patient's perception of the sound received through said first tube of said plug; and,
determining a correct amplification for a hearing aid to be worn by the patient in the ear being tested.
